(19) United States
(12) Patent Application Publication
(10) Pub. No.: US 2007/0212167 A1
(43) Pub. Date: Sep. 13, 2007

(54) Connection between bicycle crank and axle

(76) Inventor: Douglas Chiang, Ta-Li City (TW)

Correspondence Address: PHILLIP LIU, 6980, WHITEOAK DR., RICHMOND, BC, V7EAZ9, CA

(21) Appl. No.: 11/368,497

(22) Filed: Mar. 7, 2006

(51) Int. Cl. B25G 3/28

(52) U.S. Cl. 403/359.1

(57) ABSTRACT

A crank assembly includes a crank having a recess defined in a first end thereof and the recess includes an open end in an inside of the crank and a close end on an outside of the crank. A deformable material is located at an inner periphery of the recess. An axle has a groove defined in an outer periphery thereof and the deformable material is deformed and force-fitted into the groove of the crank when an end of the axle is inserted into the recess. The axle further includes a flange which seals the open end of the recess.

### FIELD OF THE INVENTION

The present invention relates to a crank assembly wherein the crank includes a recess for receiving an end of an axle and the recess includes deformable material which is deformed and force-fitted into a groove in the axle.

### BACKGROUND OF THE INVENTION

A conventional bicycle crank assembly is generally includes a flat and elongate crank which has two holes defined through the two ends of the crank and an axle and a pedal are respectively connected with the two holes in the crank. Because the two holes are defined through the crank so that water and dust easily enter the holes from outside of the crank and cause rusting and wearing. Once rusting happens in the connection between the crank and the axle, the users have to tread the pedals with more efforts.

The primary object of the present invention is to provide a crank assembly wherein the axle is securely inserted in to a recess defined in an inside of the crank and the crank includes a deformable material at an inner periphery of the recess so that when the crank is inserted into the recess, the deformable material is deformed and securely engaged with a groove of the crank such that the connection between the crank and the axle is reinforced.

Another object of the present invention is to provide a crank assembly wherein the recess of the crank is closed on the outside of the crank so that water and dust cannot enter into the recess from outside of the crank assembly.

A further object of the present invention is to provide a crank assembly wherein the axle includes a flange which closes the open end of the recess of the crank to avoid water and dust from entering the recess from the inside of the crank.

### SUMMARY OF THE INVENTION

The present invention relates to a crank assembly which includes a crank having a recess defined in a first end thereof and the recess includes an open end defined in an inside of the crank and a close end on an outside of the crank. A deformable material is located at an inner periphery of the recess. An axle has a groove defined in an outer periphery thereof and an end of the axle is inserted into the recess. The deformable material is deformed and force-fitted into the groove of the crank.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the crank assembly of the present invention;

FIG. 2 is a cross sectional view to show the crank and the axle of the present invention;

FIG. 3 is a cross sectional view to show that the crank and the axle of the present invention are connected with each other, and

FIG. 4 shows the outside of the crank assembly of the present invention.

### DETAILED DESCRIPTION OF THE PREFERRED EMBODIMENT

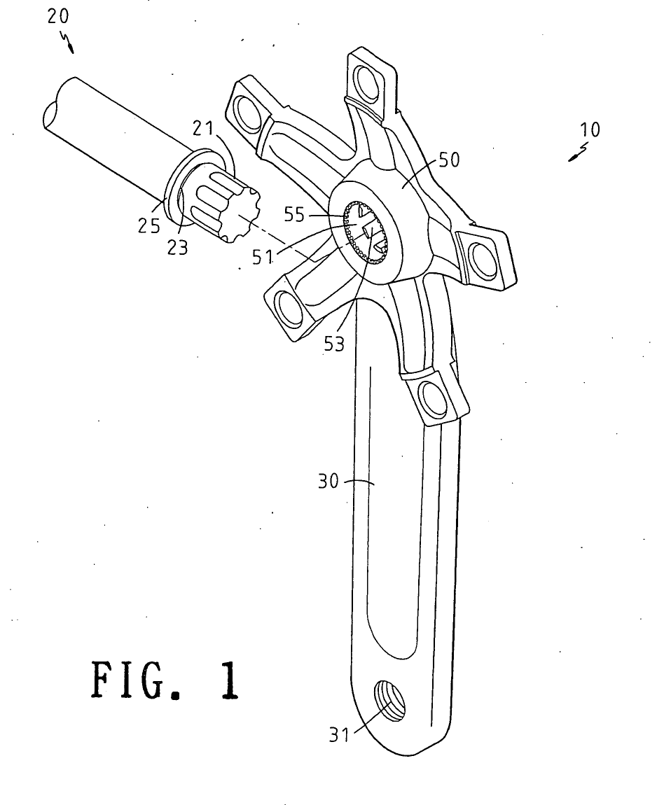

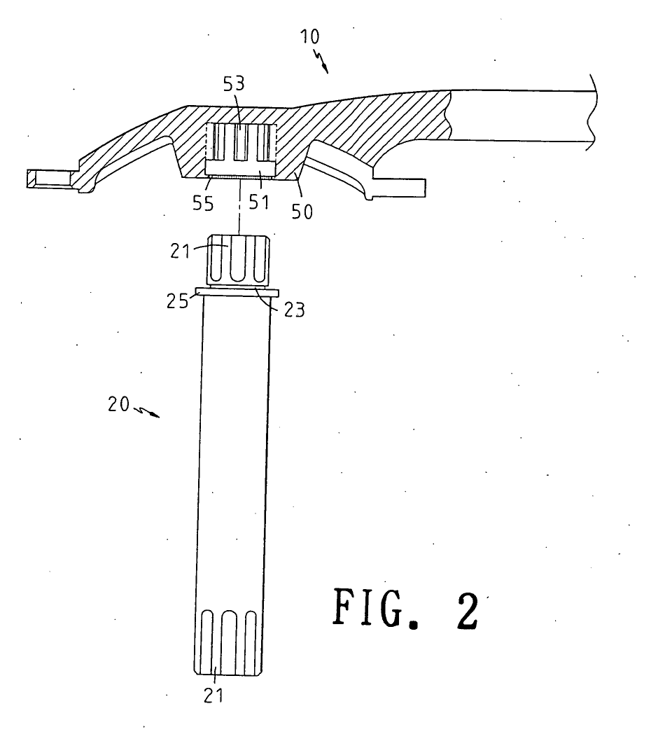

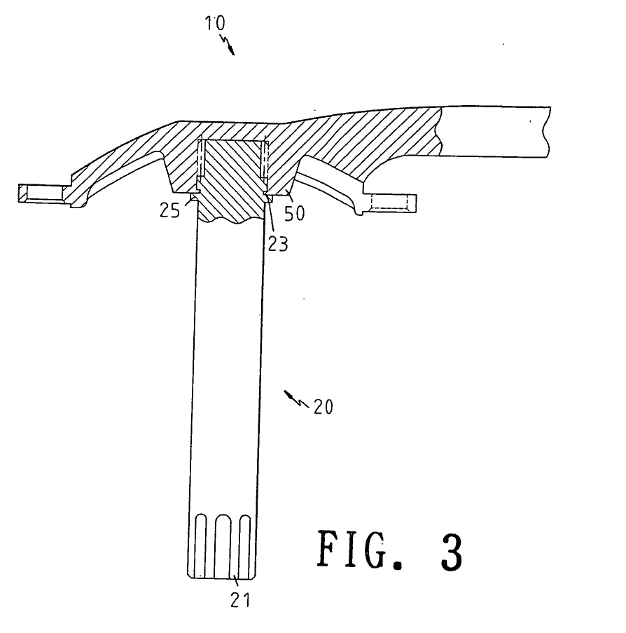

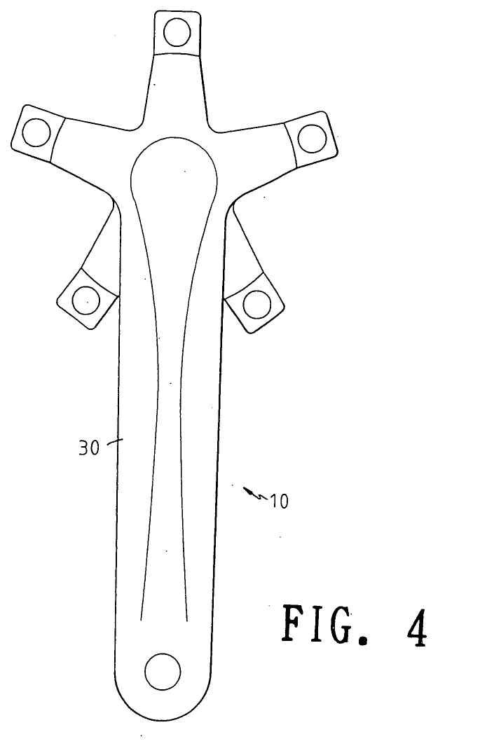

Referring to FIGS. 1 to 4, the crank assembly 10 of the present invention comprises a crank 30 which is a flat and elongate bar. A connector 50 is connected to a first end of the crank 30 and a recess 51 is defined in the connector 50. The recess 51 includes an open end defined in an inside of the crank 30 and a close end on an outside of the crank 30. A threaded hole 31 is defined through a second end of the crank 30 so as to be connected with a pedal which is not shown. A plurality of engaging slots 53 are defined longitudinally in the inner periphery of the recess 51 and a length of each of the engaging slots 53 is shorter than a depth of the recess 51. A deformable material 55 is located at an inner periphery of the recess 51.

An axle 20 has a groove 23 defined in an outer periphery thereof and an end of the axle 20 is inserted into the recess 51. The axle 20 has a plurality of ridges 21 which are engaged with the engaging slots 53, and the deformable material 55 is deformed and force-fitted into the groove 23 of the crank 30. A flange 25 extends radially outward from the axle 20 and seals the open end of the recess 51.

Adhesive can be applied to the inner periphery of the recess 51 and/or the end of the axle 20 so that the axle 20 can be firmly engaged with the recess 51.

Because the recess 51 has the close end on the outside of the crank 30 and the flange 25 further seals the open end of the recess 51 in the inside of the crank 30, so that dust and water cannot enter into the recess 51 from outside of the crank 30. Besides, the deformable material 55 is located at the inner periphery of the open end of the recess 51 and is force-fitted into the groove 23, which further ensures the connection between the axle 20 and the crank 30.

While we have shown and described the embodiment in accordance with the present invention, it should be clear to those skilled in the art that further embodiments may be made without departing from the scope of the present invention.

1. A crank assembly comprising:
a crank having a recess defined in a first end thereof and the recess including an open end defined in an inside of the crank and a close end on an outside of the crank, a deformable material located at an inner periphery of the recess, and
an axle having a groove defined in an outer periphery thereof and an end of the axle being inserted into the recess, the deformable material being deformed and force-fitted into the groove of the axle, a flange extending radially outward from the axle and sealing the open end of the recess.

2. The crank assembly as claimed in claim 1, wherein a plurality of engaging slots are defined longitudinally in the inner periphery of the recess and the axle has a plurality of ridges which are engaged with the engaging slots.

3. The crank assembly as claimed in claim 2, wherein a length of each of the engaging slots is shorter than a depth of the recess.

4. (canceled)

5. A crank assembly comprising:
a crank having a recess defined in a first end thereof and the recess including an open end defined in an inside of the crank and a close end on an outside of the crank, and
an axle having an end thereof inserted into the recess and a flange extending radially outward from the axle and sealing the open end of the recess.

6. The crank assembly as claimed in claim 5, wherein a plurality of engaging slots are defined longitudinally in the inner periphery of the recess and the axle has a plurality of ridges which are engaged with the engaging slots.

7. The crank assembly as claimed in claim 6, wherein a length of each of the engaging slots is shorter than a depth of the recess.

8. The crank assembly as claimed in claim 5 further comprising a deformable material located at an inner periphery of the recess and the axle having a groove defined in an outer periphery thereof, the deformable material being deformed and force-fitted into the groove of the axle when the end of the axle is inserted into the recess.
